(19) United States
(12) Patent Application Publication
(10) Pub. No.: US 2017/0323590 A1
(43) Pub. Date: Nov. 9, 2017

(54) DISPLAY APPARATUS

(71) Applicant: Corporacion Papelera Imperial, S.A., Edo de Mexico (MX)

(72) Inventors: Isaac Saad Moazeb, Edo de Mexico (MX); Joe Saad Moazeb, Edo de Mexico (MX)

(21) Appl. No.: 15/585,892

(22) Filed: May 3, 2017

Related U.S. Application Data
(60) Provisional application No. 62/332,061, filed on May 5, 2016.

(51) Int. Cl. G09F 7/12; G09F 15/00

(52) U.S. Cl. CPC G09F 7/12; G09F 15/0006; G09F 2007/127

(57) ABSTRACT

A display apparatus including a poster board having adhesive on one of its major surfaces. The display apparatus may include a poster board comprising a front surface and a rear surface opposite the front surface; a first strip of adhesive and a second strip of adhesive positioned on the rear surface of the poster board; a first release sheet coupled to and covering the first strip of adhesive and a second release sheet coupled to and covering the second strip of adhesive; and wherein the first and second strips of adhesive are formed from rubber cement.

### CROSS-REFERENCE TO RELATED APPLICATIONS

The present application claims the benefit of U.S. Provisional Patent Application Ser. No. 62/332,061, filed May 5, 2016, the entirety of which is incorporated herein by reference.

### FIELD OF THE INVENTION

The present invention relates to a poster board or other flat article having adhesive thereon.

### BACKGROUND OF THE INVENTION

Poster boards are used to display and present a variety of information including business information, advertising information, and educational information. Furthermore, poster boards are frequently used by children for creating artistic works and by students to present information at science fairs and other presentation forums. It is often desirable to hang such a poster board from a vertical surface such as a wall in a home or building. However, conventional adhesive often sticks to the wall and damages the drywall or paint thereon or sticks to the poster board resulting in the poster board tearing and/or ripping during removal of the adhesive. Furthermore, other conventional adhesive lacks sufficient adhesion to support a poster board from a vertical surface. Thus, a need exists for an adhesive poster board that cures these deficiencies.

### SUMMARY OF THE INVENTION

The present invention is directed to a poster board having adhesive on its rear surface with its front surface free of adhesive. The adhesive may be arranged in strips along the rear surface of the poster board. In some embodiments, the adhesive may comprise rubber cement such that the adhesive is readily detachable from the rear surface of the poster board without causing damage to the poster board. In some embodiments, the poster board may have two strips of adhesive thereon, each spaced a different distance from the top and bottom edges of the poster board to which they are adjacent.

In one embodiment, the invention may be a display apparatus comprising: a poster board comprising a top edge, a bottom edge, a first lateral edge, a second lateral edge, a front surface, and a rear surface; a first strip of adhesive positioned on the rear surface of the poster board and extending from the first lateral edge to the second lateral edge, the first strip of adhesive spaced a first distance D1 from the top edge of the poster board; a second strip of adhesive positioned on the rear surface of the poster board and extending from the first lateral edge to the second lateral edge, the second strip of adhesive spaced a second distance D2 from the bottom edge of the poster board; wherein the first strip of adhesive is spaced apart from the second strip of adhesive by a third distance D3, the third distance D3 being greater than the second distance D2 and the second distance D2 being greater than the first distance D1; and wherein the front surface of the poster board is free of any adhesive thereon.

In another embodiment, the invention may be a display apparatus comprising: a poster board comprising a top edge, a bottom edge, a first lateral edge, a second lateral edge, a front surface, and a rear surface; a first strip of adhesive positioned on the rear surface of the poster board and extending from the first lateral edge to the second lateral edge, the first strip of adhesive spaced a first distance D1 from the top edge of the poster board; a second strip of adhesive positioned on the rear surface of the poster board and extending from the first lateral edge to the second lateral edge, the second strip of adhesive spaced a second distance D2 from the bottom edge of the poster board; and wherein a ratio of D2:D1 is between 2.4 and 2.8.

In yet another embodiment, the invention may be a display apparatus comprising: a poster board comprising a front surface and a rear surface opposite the front surface; a first strip of adhesive and a second strip of adhesive positioned on the rear surface of the poster board; a first release sheet coupled to and covering the first strip of adhesive and a second release sheet coupled to and covering the second strip of adhesive; and wherein the first and second strips of adhesive are formed from rubber cement.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a display apparatus including a poster board in a partially rolled-up configuration in accordance with an embodiment of the present invention;

FIG. 2 is a front view of the display apparatus of FIG. 1;

FIG. 3 is a rear view of the display apparatus of FIG. 1;

FIG. 4 is a close-up rear view of the display apparatus of FIG. 1;

FIG. 5 is a rear view of the display apparatus of FIG. 1 illustrating release sheets being removed from the poster board to expose an adhesive;

FIG. 6 is a rear view of the display apparatus of FIG. 1 with the release sheets removed and the adhesive fully exposed;

FIG. 7 is a front view of one of the release strips of the display apparatus of FIG. 1;

FIG. 8 is a schematic view of a display apparatus in accordance with a first alternative embodiment of the present invention;

FIG. 9 is a schematic view of a display apparatus in accordance with a second alternative embodiment of the present invention;

FIG. 10 is a schematic view of a display apparatus in accordance with a third alternative embodiment of the present invention;

FIG. 11 is a schematic view of a display apparatus in accordance with a fourth alternative embodiment of the present invention; and

FIG. 12 is a schematic view of a display apparatus in accordance with a fifth alternative embodiment of the present invention.

### DETAILED DESCRIPTION OF THE INVENTION

The following description of the preferred embodiment(s) is merely exemplary in nature and is in no way intended to limit the invention, its application, or uses.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

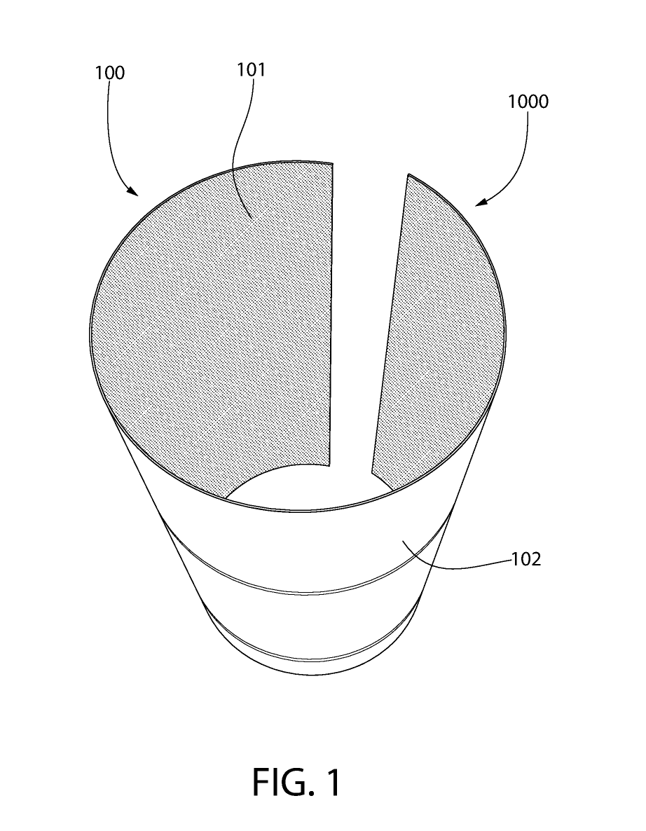

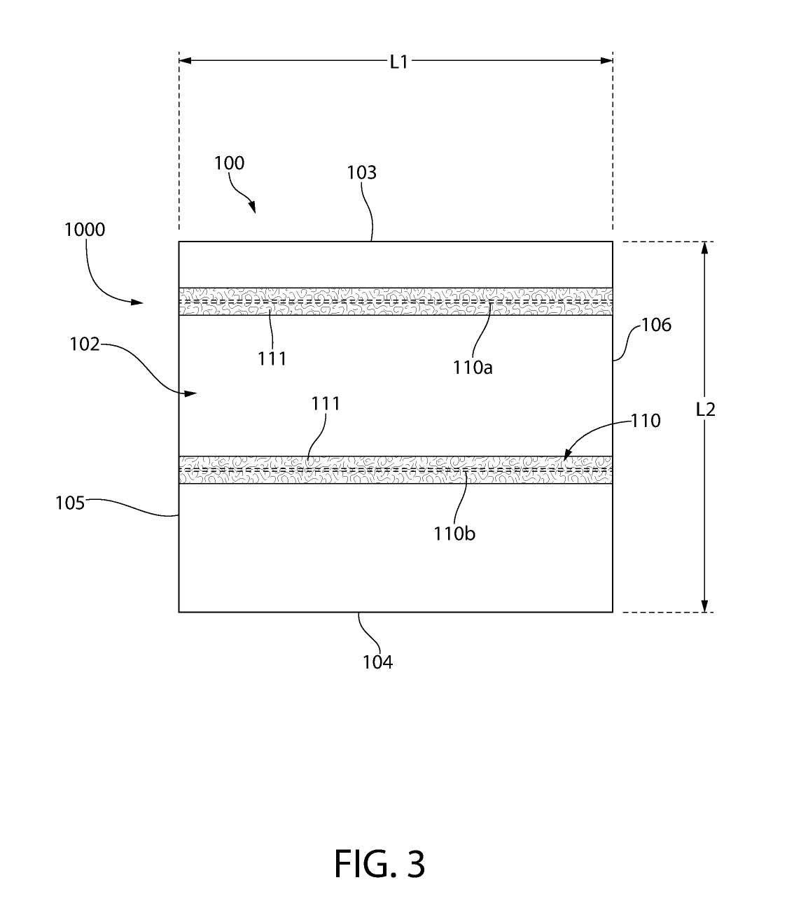

Referring to FIGS. 1-3 concurrently, a display apparatus 1000 is illustrated in accordance with an embodiment of the present invention. The display apparatus 1000 generally comprises a poster board 100 having adhesive 110 and release sheets 111 thereon. The poster board 100 is a sheet of material having a front surface 101 and an opposing rear surface 102. Both the front and rear surfaces 101, 102 are flat, planar surfaces in the exemplified embodiment, although in other embodiments these surfaces may include ridges, indentations, or other textures. The front surface 101 may be white or colored depending on its desired use, although it is colored in the exemplified embodiment. Similarly, the rear surface 102 may be white or colored, although it is white in the exemplified embodiment. Thus, in one exemplified embodiment, the front surface 101 comprises a non-white color and the rear surface comprises a white color. The non-white color of the front surface 101 may be any desired color and the specific color is not to be limiting. In some embodiments, both of the front and rear surfaces 101, 102 are non-white colors. In some embodiments the front surface 101 may comprise a first color (white or non-white) and the second surface 102 may comprise a second color (white or non-white), the second color being different than the first color. The front surface 101 may be multi-colored in some alternative embodiments.

The poster board 100 in the exemplified embodiment is rectangular in shape and is bounded by a top edge 103, a bottom edge 104, a first lateral edge 105, and a second lateral edge 106. The top edge 103 is adjacent to the first and second lateral edges 105, 106 and opposite the bottom edge 104. The bottom edge 104 is adjacent to the first and second lateral edges 105, 106 and opposite the top edge 103. The first and second lateral edges 105, 106 are adjacent to both the top and bottom edges 103, 104 but are opposite one another. In the exemplified embodiment, the top and bottom edges 103, 104 have a first length L1 and the first and second lateral edges 105, 106 have a second length L2, the first length L1 being greater than the second length L2. Although the poster board 100 is illustrated as rectangular in the exemplified embodiment, the invention is not to be so limited in all embodiments and the poster board 100 may take on other shapes including non-polygonal (i.e., circular) and polygonal shapes such as triangular, square, hexagonal, octagonal, and the like.

The poster board 100 may be a standard poster board formed of a sheet of paper-like material, cardboard, foam, or the like. The poster board 100 may be relatively flimsy such that it can be rolled up into a tube-like shape or it may be more rigid such that it cannot be readily rolled or folded. The poster board 100 may have any desired length, width, and thickness in some embodiments, although in certain embodiments the thickness is approximately 1 mm or less, and more specifically approximately 0.5 mm or less.

The front surface 101 of the poster board 100 is the surface of the poster board 100 that is generally written on or otherwise decorated by a user and is exposed for viewing when the poster board 100 is on display. Specifically, a user can write directly onto the front surface 101 of the poster board 100 using a pen, marker, crayons, pencil, or the like as desired. Alternatively or additionally, the user can tape or glue other objects, including magazine cutouts, ornaments, three-dimensional objects, or the like onto the front surface 101 of the poster board 100. In certain embodiments the rear surface 102 of the poster board 100 is not intended to be decorated by the user. However, the rear surface 102 of the poster board 100 may be made of material that is capable of being written on or otherwise decorated, and thus in some embodiments the rear surface 102 of the poster board 100 may be decorated in addition to the front surface 101 of the poster board 100.

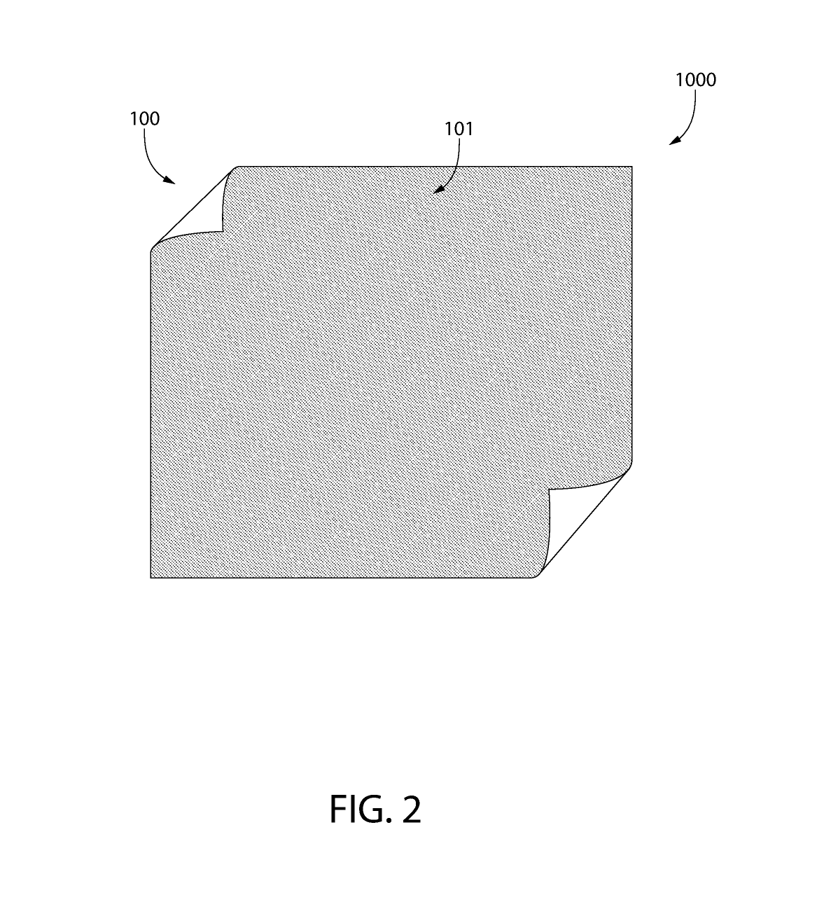

Referring to FIGS. 1 and 2, in the exemplified embodiment the front surface 101 of the poster board 100 is free of any adhesive thereon. Stated another way, the front surface 101 has absolutely no adhesive (tape, glue, or the like) of any kind thereon. Thus, the entirety of the front surface 101 of the poster board 100 is available for a user to decorate as described above without interference by an adhesive.

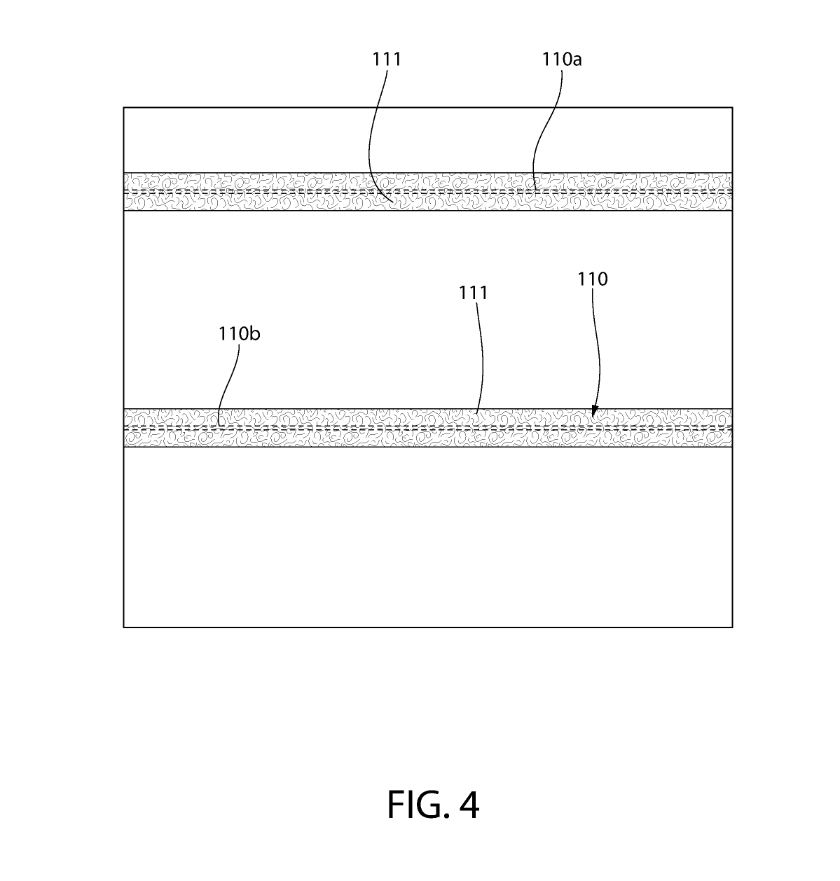

Referring to FIGS. 1, 3, 4, and 6 in the exemplified embodiment the rear surface 102 of the poster board 100 contains adhesive 110 thereon and a release sheet 111 covering the adhesive 110. The adhesive 110 on the rear surface 102 of the poster board 100 in the exemplified embodiment is provided as two strips of adhesive 110a, 110b (i.e., a first strip of adhesive 110a and a second strip of adhesive 110b). The adhesive may be any type of adhesive such as, without limitation, glue, tape (i.e., double sided tape), cement, rubber cement adhesive strips, pressure sensitive adhesive, spray glue, or the like. In other embodiments, the adhesive may be hook-and-loop tape or the like.

In certain embodiments, the adhesive 110 may comprise rubber cement, which is an adhesive made from elastic/elastomeric polymers (e.g., latex , natural rubber, gum mastic, gum arabic, pre-vulcanized rubber, non-pre-vulcanized rubber, or the like) mixed in a solvent such as acetone, hexane, heptane, toluene, chloroform, or benzene. The solvent keeps the elastic polymers fluid enough to be spread onto a desired surface. Upon drying the solvent evaporates leaving only the rubber-like portion behind which functions as the adhesive. Rubber cement, when used as an adhesive, permits easy and damage-free removal of the adhesive from the surface(s) on which it is applied as desired. Specifically, when rubber cement is used as the adhesive 110, the adhesive 110 may be easily peeled or rubbed off of the rear surface 102 of the poster board 1000 without damaging the poster board 1000 or leaving any trace of the adhesive 110 behind. Thus, in certain embodiments the adhesive 110 is one that removes cleanly from both the rear surface 102 of the poster board 100 and a painted wall surface on which the poster board 100 is hung while still having an adhesive strength that is sufficient to hang the poster board 100 from a vertical surface such as a wall.

In some embodiments, the strips of adhesive 110a, 110b may have an adhesive strength such that the first and second strips of adhesive 110a, 110b can be readily removed from the rear surface of the poster board 100 under ambient conditions without damaging the poster board 100. The strips of adhesive 110a, 110b can also be readily removed from the wall on which the poster board 100 is hung under ambient conditions without damaging the poster board 100. As used herein, “ambient conditions” refers to a normal room temperature (approximately 70-75° F.) and to the lack of a use of any chemicals to assist in the removal of the adhesive 110 from the poster board 100. Thus, the strips of adhesive 110a, 110b can be removed from the poster board 100 and/or the wall readily by a user's hand without any chemical or temperature-based assistance. The strips of adhesive 110a, 110b have a consistent adhesive strength as opposed to having different adhesive strengths on the portion that is attached to the poster board 100 and the portion that is attached to the wall. Furthermore, the adhesive 110 is not what might be referred to as a permanent adhesive, but rather it is one that has a relatively weak bond with both surfaces to which is it adhered (i.e., the rear surface 102 of the poster board 100 and the wall from which the poster board 100 is hung) while being sufficiently strong to be capable of maintaining the poster board 100 in a vertical orientation on the wall.

The poster board 100 may be hung from a painted wall surface (or other vertical surface) by pressing the rear surface 102 of the poster board 100, and hence also the adhesive 110 thereon, against the painted wall surface. The adhesiveness of the adhesive 110 will stick the poster board 100 to the painted wall surface and allow the poster board 100 to be hung therefrom. The poster board 100 can be removed from the painted wall surface by a user applying a pulling force pulling the poster board 100 away from the painted wall surface. The material of the adhesive 110 is desirably selected such that this action does not remove paint from or otherwise damage the painted wall surface.

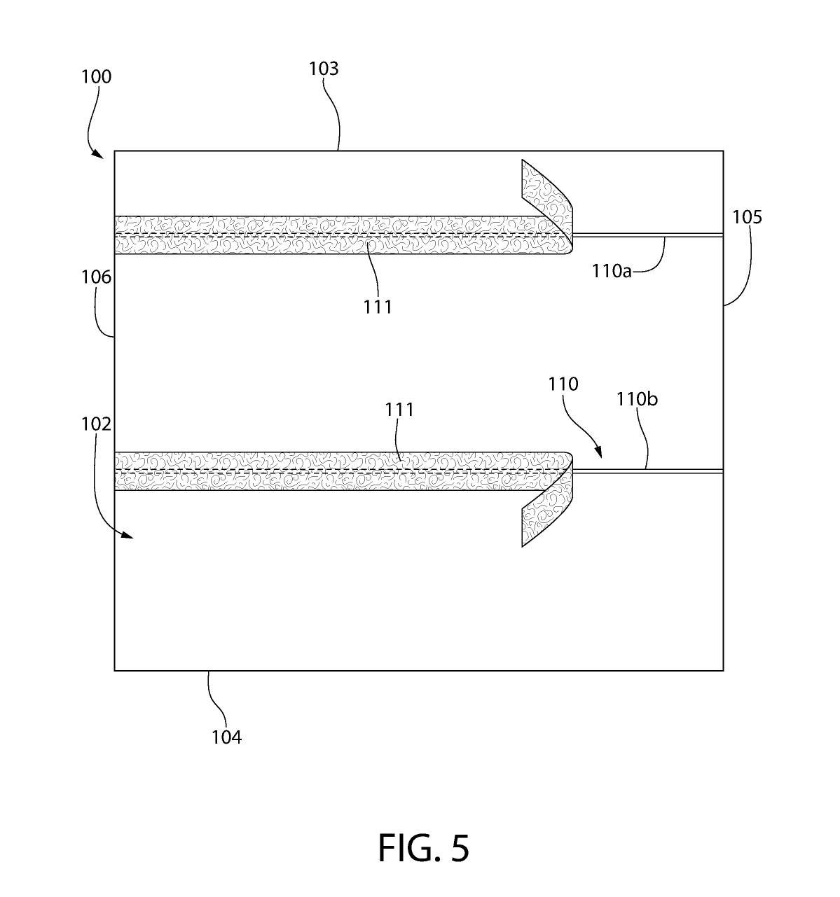

Referring to FIG. 5, an illustration is provided showing the release sheets 111 being removed or separated from the adhesive 110 on the rear surface 102 of the poster board 100. As the release sheets 111 are removed, the adhesive 110 on the rear surface 102 of the poster board 100 becomes exposed so that the poster board 100 can be adhered to a surface, such as a wall, a table, a window, or the like.

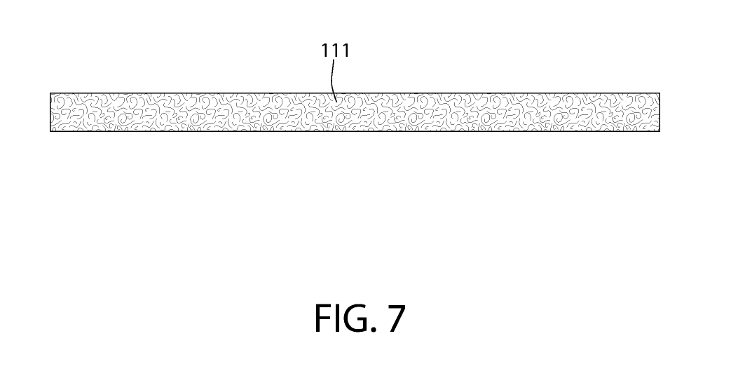

FIG. 7 is an illustration of one exemplary embodiment of the release sheets 111. The release sheets 111 may be standard release-type liners that are used to prevent the adhesive 110 from prematurely adhering. The release sheets 111 are elongated, thin pieces of paper commonly referred to in the art as release paper or release liners. The release sheets 111 may in some embodiments be paper, poly-coated paper, polyester film, high-density polyethylene film, or the like. The release sheets 111 may include silicone release coatings on one or both major surfaces thereof. The release sheets 111 are any type of paper or plastic-based film sheet used to prevent a sticky surface (i.e., the adhesive 110) from prematurely adhering to another surface or object. The release sheets 111 may alternatively be a bag or a bag-like material. Specifically, the release sheets 111 cover the entirety of the adhesive 110 until it is desired to use the adhesive 110 to adhere the poster board 100 to another surface or object and to maintain keep the adhesive 110 free of debris (i.e., dust, hair, etc.) that might affect the adhesiveness of the adhesive 110.

The release sheets 111 may have dimensions that are similar to but slightly larger than the dimensions of the adhesive 110. Thus, the release sheets 111 may cover the entirety of the adhesive 110 while leaving the remainder of the rear surface 102 of the poster board 100 exposed and not covered. Thus, the surface area of the release sheets 111 is significantly less than the surface area of the rear surface 102 of the poster board 100. Of course, the invention is not to be so limited in all embodiments and in other embodiments a single release sheet may be used that covers a substantial entirety of the rear surface 102 of the poster board 100. The release sheets 111 may be white or non-white in certain embodiments, and in some preferable embodiments the release sheets 111 may comprise a blue color. In some embodiments the release sheets 111 may comprise a third color that is different than the first color of the front surface 101 of the poster board 100 and the second color of the rear surface 102 of the poster board 100.

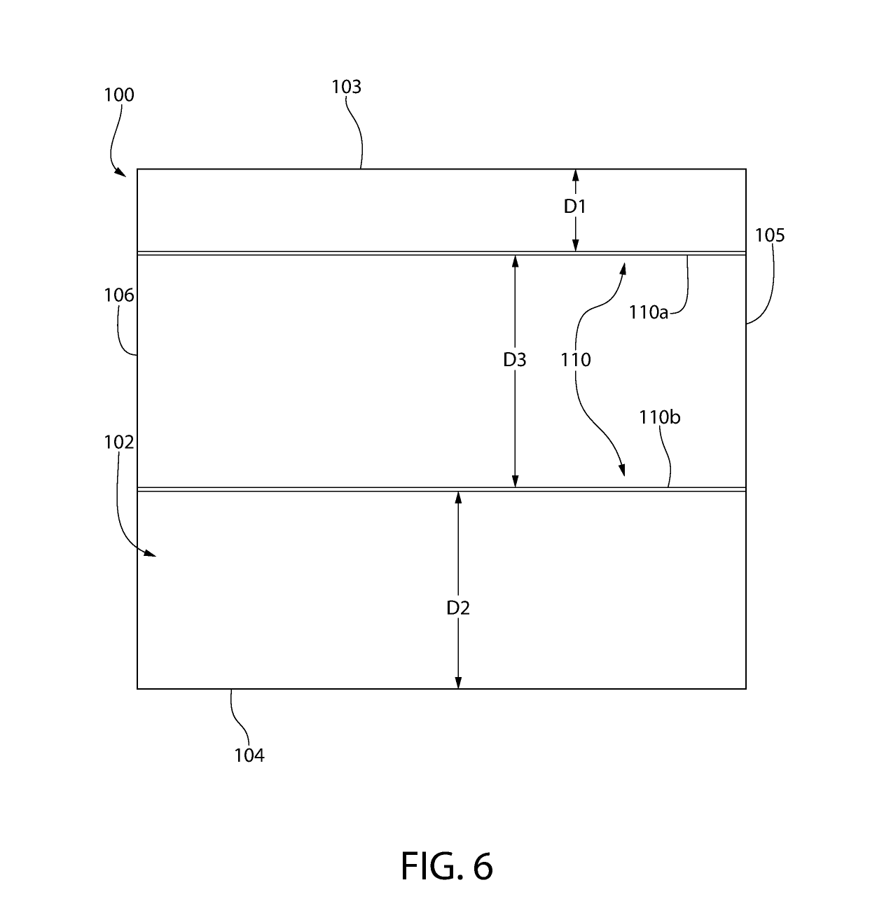

FIG. 6 illustrates the rear surface 102 of the poster board 100 after the release sheets 111 have been detached or removed from the adhesive 110 so that the adhesive 110 is exposed. In this embodiment, the adhesive 110 is provided on the rear surface 102 of the poster board 100 in two strips extending across the poster board 100 from the first lateral edge 105 to the opposite second lateral edge 106. However, the invention is not to be so limited in all embodiments and in other embodiments the adhesive 110 may be provided in strips that are more centrally located so that they do not extend to the opposing lateral ends 105, 106 thereof. Specifically, there may be a perimeter region (i.e., a one inch, two inch, or the like wide margin area around the entire perimeter) of the rear surface 102 of the poster board 100 that is free of the adhesive 110. In the exemplified embodiment, each strip of the adhesive 110 has a width measured in a direction parallel to the first and/or second lateral edges 105, 106 of the poster board 100 that is between 1 mm and 5 mm, and more specifically between 2 mm and 3 mm. Of course, the adhesive strips 110 may have widths that are outside of the noted ranges in some alternative embodiments.

In still other embodiments, the adhesive 110 may be provided in vertical strips that extend between the top and bottom edges 103, 104 of the poster board 100 (with or without a margin area that is free of the adhesive as noted above). In further embodiments, the adhesive 110 may be in horizontal and vertical strips that form square or rectangular-like adhesive strips (or other shaped adhesive strips as desired). In the exemplified embodiment, the adhesive 110 is provided in continuous linear strips. In other embodiments the adhesive 110 may be provided in continuous wavy strips. In still other embodiments, the adhesive 110 may be non-continuous segments of adhesive that form an overall linear or wavy arrangement. Such non-continuous strips may be small, spaced apart segments of the adhesive 110. The adhesive 110 may be small dots, small spaced apart linear segments, or the like extending across a portion of or the entirety of the rear surface 102 of the poster board 100. In one embodiment the adhesive 110 may be dots of adhesive in each of the corners of the rear surface 102 of the poster board 100. In other embodiments the adhesive 110 may extend along a perimeter of the rear surface 102 of the poster board 100 but not along the central regions thereof. The term “strips of adhesive” includes linear, wavy, continuous, or discontinuous strips of the adhesive. Thus, stating that the strips of adhesive 110a, 110b extend from the first lateral edge 105 to the second lateral edge 106 includes the strips of adhesive 110a, 110b extending in a linear manner, a wavy manner, a continuous/gap-free manner, or a discontinuous/segmented manner across the rear surface 102 of the poster board 100 unless otherwise recited in the claims. Although two strips of adhesive 110 are illustrated, in other embodiments one strip or more than two strips may be used.

In the exemplified embodiment, the adhesive 110 may be transparent. However, the invention is not to be so limited and in other embodiments the adhesive 110 may be opaque or otherwise non-transparent so that a user can readily discern the location of the adhesive 110. In certain embodiments the adhesive 110 may comprise a color that contrasts with the color of the rear surface 102 of the poster board 100 on which it is located. This enables a user to easily identify which surface is the front surface 101 of the poster board 100 for decorating/writing and which surface is the rear surface 102 of the poster board 100 that is intended to adhere to a wall or other surface for display or the like.

Still referring to FIG. 6, in the exemplified embodiment there are two strips of adhesive 110 on the rear surface 102 of the poster board 100. The two strips of adhesive 110 include an upper strip 110a that is located adjacent the top edge 103 of the poster board 100 and a lower strip 110b that is located adjacent the bottom edge 104 of the poster board 100. The upper strip 110a is spaced a first distance D1 from the top edge 103 of the poster board 100. The lower strip 110b is spaced a second distance D2 from the bottom edge 104 of the poster board 100. Furthermore, the upper and lower strips 110a, 110b are spaced a third distance D3 from one another. The third distance D3 is greater than the second distance D2, and the second distance D2 is greater than the first distance D1. Thus, the upper strip 110a is closer to the top edge 103 of the poster board 100 than the lower strip 110b is to the bottom edge 104 of the poster board 100.

In certain embodiments, at least one of the first and second distances is greater than 2 inches. In some embodiments, both of the first and second distances D1, D2 are greater than 2 inches. In one embodiment, D1 is between 2-3 inches (6-7 cm) and D2 is between 6-7 inches (16-18 cm). Furthermore, in some embodiments D3 is between 23-24 cm. However, the invention should be not limited by these specific distances and other distances are possible particularly depending on the overall dimensions of the poster board 100. However, in some embodiments it is desirable to ensure a sufficient second distance D2 to allow for easy gripping of the poster board 100 when it is stuck to a wall in order to be able to readily separate the poster board 100 from the wall as discussed herein.

By positioning the upper and lower strips 110a, 110b as depicted in FIG. 6, there is a greater length of the poster board 100 between the lower strip 110b and the bottom edge 104 of the poster board 100 than there is between the upper strip 110a and the top edge 103 of the poster board 100. This provides a portion of the poster board 100 that can be gripped by a user (i.e., the portion between the lower strip 110b and the bottom edge 104 of the poster board 100) to detach the poster board 100 from a surface after it has been adhered thereto. Furthermore, locating the upper strip 110a near the top edge 103 prevents the top portion of the poster board 100 from bending upon itself or rippling when the poster board 100 is hung from a vertical surface.

Furthermore by not positioning the lower strip 110b closer to the bottom edge 104 of the poster board 100 (so that D2 equals D1), the middle section of the poster board 100 can be prevented from rippling or trapping air bubbles between the poster board 100 and the wall when the poster board 100 is hung from a vertical surface. Specifically, and depending on the size of the poster board, it has been found that when the upper and lower strips 110a, 110b are positioned further away from each other such that the upper strip 110a is less than 5 inches away from the top edge 103 and the lower strip 110b is less than 5 inches away from the bottom edge 104, the region between the upper and lower strips 110a, 110b may trap air bubbles between the rear surface 102 of the poster board 100 and the vertical surface rather than remaining flat against the vertical surface. Stated another way, this air bubble trapping occurs when a length of the region between the upper and lower strips 110a, 110b is too great. Therefore, a ratio of D3:D2 may be less than 1.5, in some embodiments the ratio of D3:D2 is between 1.1 and 1.5, more specifically between 1.2 and 1.4, and still more specifically between 1.3 and 1.4. Furthermore, a ratio of D3:D1 may be between 3.0 and 4.0, more specifically between 3.2 and 3.8, still more specifically between 3.4 and 3.8, and even more specifically between 3.6 and 3.7. Furthermore, a ratio of D2:D1 may be between 2.0 and 3.0, more specifically between 2.2 and 2.8, still more specifically between 2.4 and 2.8, and even more specifically between 2.6 and 2.7. Furthermore, in the exemplified embodiment D3 is approximately equal to D1 plus D2 (the term “approximately” meaning that there is a tolerance of up to 3%). Furthermore, in some embodiments a ratio of (D3+D1):D2 may be between 1.5 and 2.0, and more specifically between 1.7 and 1.8. In the exemplified embodiment, the region of the rear surface 102 of the poster board 100 between the upper and lower strips 110a, 110b of adhesive is entirely free of adhesive.

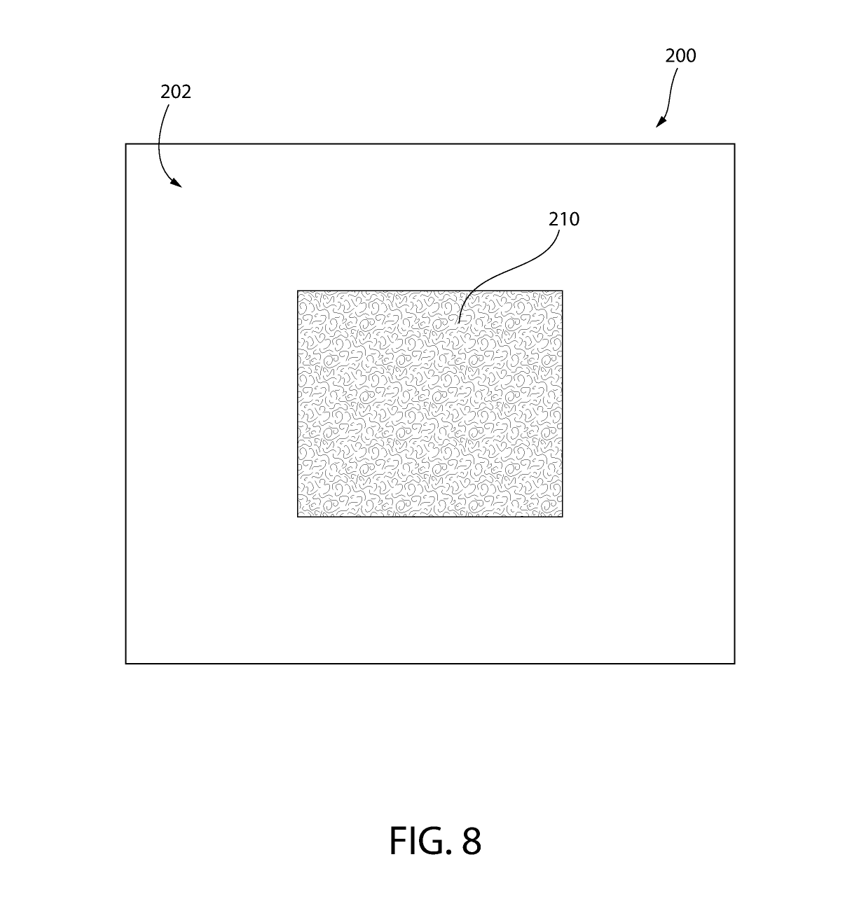

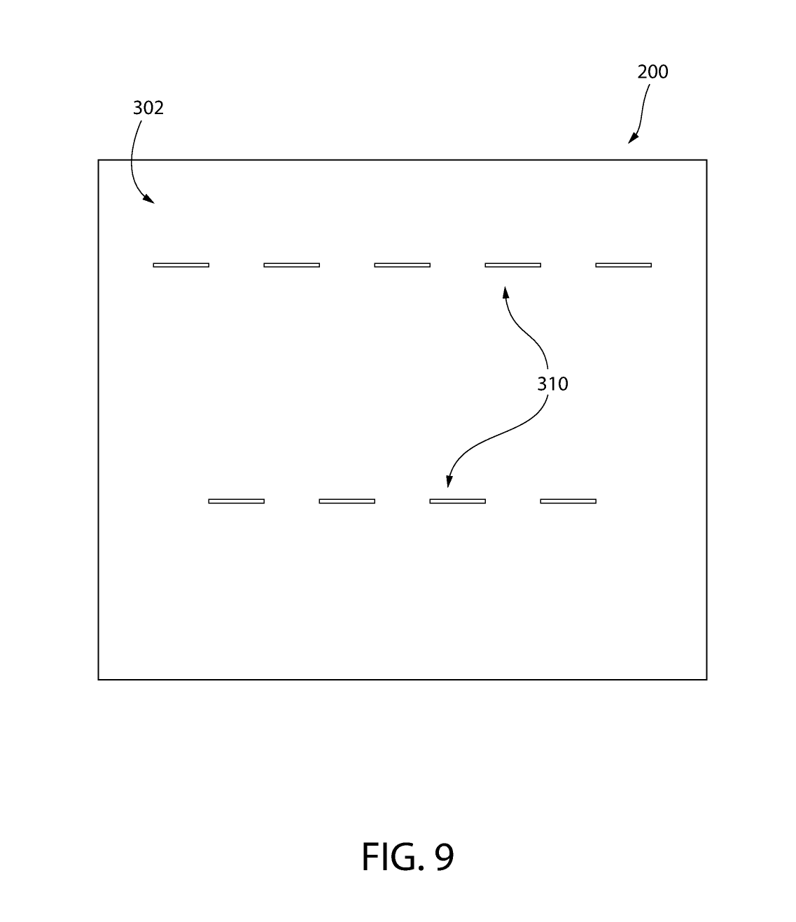

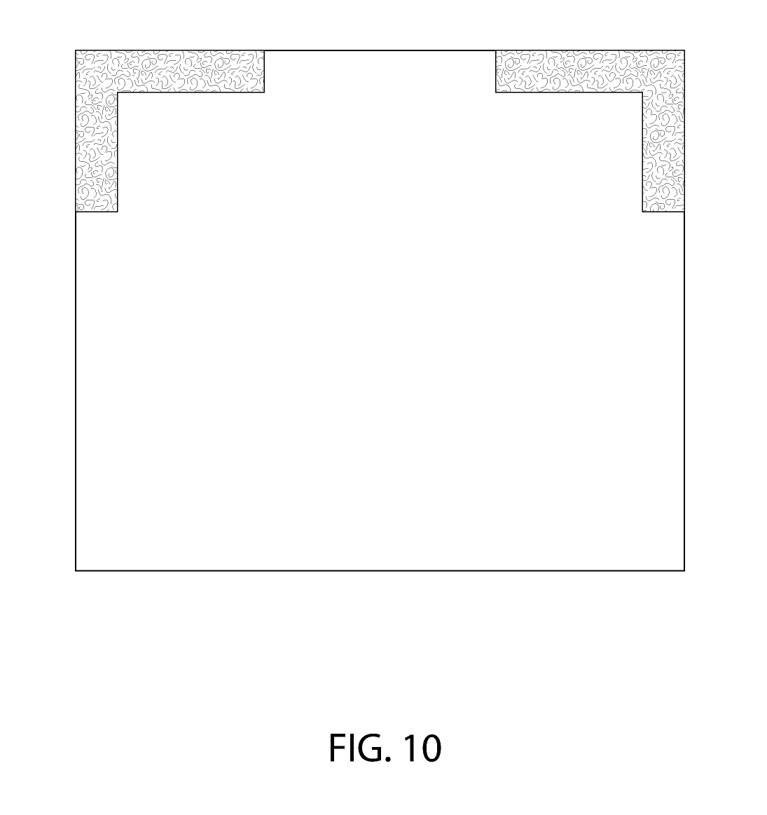

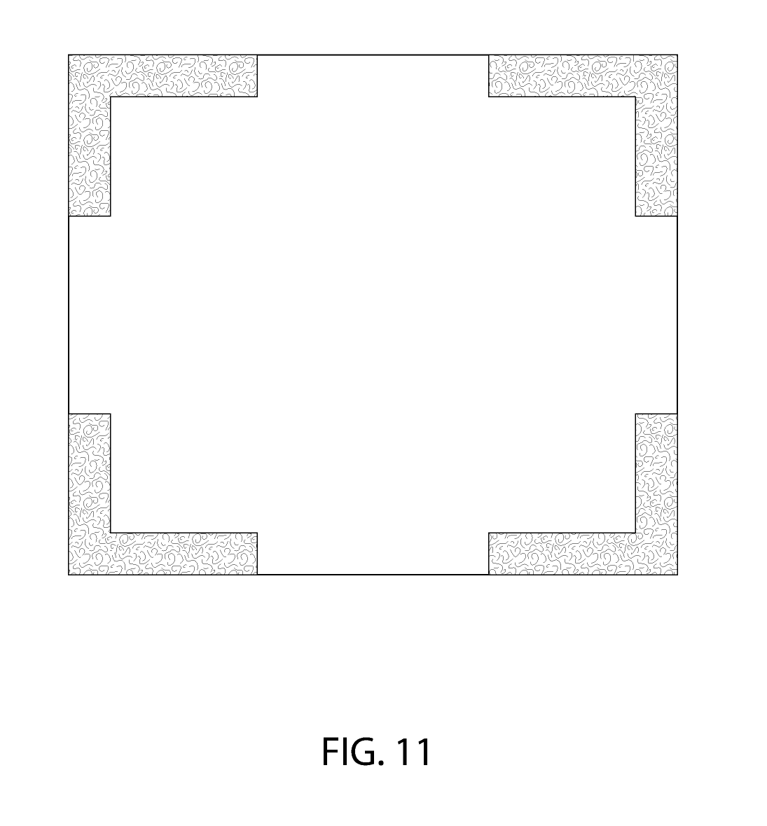

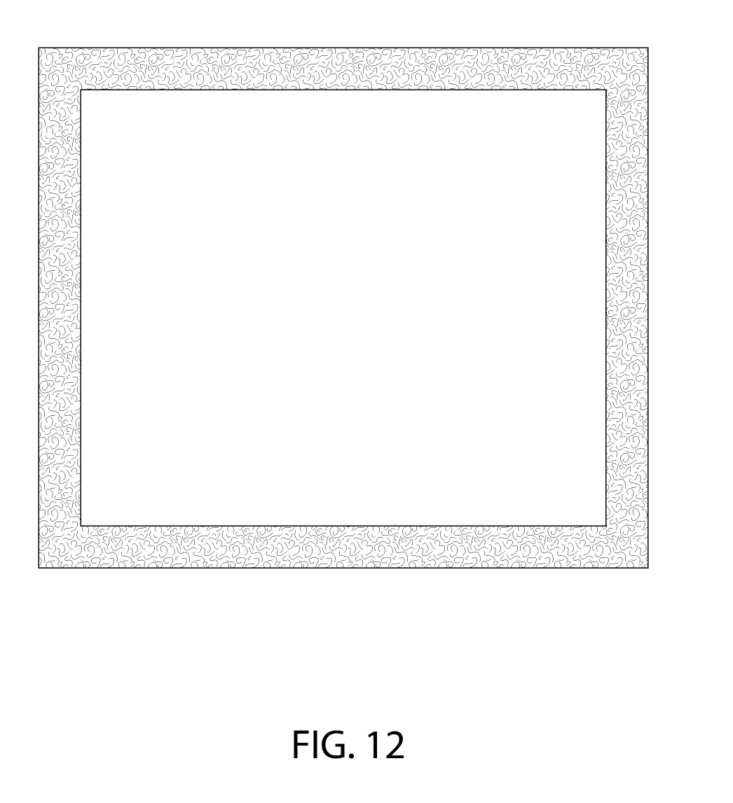

Some alternative embodiments with regard to placement of the adhesive are illustrated in FIGS. 8-12. FIG. 8 illustrates a poster board 200 with a central rectangular region of the rear surface 202 of the poster board 200 coated with an adhesive 210. Other shaped regions being coated with the adhesive 210 are possible, including circular, triangular, or the like. FIG. 9 illustrates a poster board 300 with discontinuous segments of adhesive 310 on the rear surface 302 of the poster board 300. In FIG. 9 the discontinuous segments are arranged in two linear rows, although any array of the segments are possible including a random array, linear rows, wavy rows, sinusoidal rows, or the like. Various permutations of the location and arrangement of the adhesive on the rear surface of the poster board are possible and fall within the scope of the present invention. In all embodiments, the front surface of the poster board is free of adhesive. FIG. 10 illustrates a poster board with an adhesive in an “L” shape on two of the corners. Any two corners, or three or four of the corners (FIG. 11), may have the adhesive in this manner. FIG. 12 illustrates a poster board with an adhesive around the entire perimeter.

While the invention has been described with respect to specific examples including presently preferred modes of carrying out the invention, those skilled in the art will appreciate that there are numerous variations and permutations of the above described systems and techniques. It is to be understood that other embodiments may be utilized and structural and functional modifications may be made without departing from the scope of the present invention. Thus, the spirit and scope of the invention should be construed broadly as set forth in the appended claims.

What is claimed is:

1. A display apparatus comprising:
a poster board comprising a top edge, a bottom edge, a first lateral edge, a second lateral edge, a front surface, and a rear surface;
a first strip of adhesive positioned on the rear surface of the poster board and extending from the first lateral edge to the second lateral edge, the first strip of adhesive spaced a first distance D1 from the top edge of the poster board;
a second strip of adhesive positioned on the rear surface of the poster board and extending from the first lateral edge to the second lateral edge, the second strip of adhesive spaced a second distance D2 from the bottom edge of the poster board;
wherein the first strip of adhesive is spaced apart from the second strip of adhesive by a third distance D3, the third distance D3 being greater than the second distance D2 and the second distance D2 being greater than the first distance D1; and
wherein the front surface of the poster board is free of any adhesive thereon.

2. The display apparatus according to claim 1 wherein a ratio of D3:D2 is between 1.2 and 1.4.

3. The display apparatus according to claim 2 wherein a ratio of D3:D1 is between 3.4 and 3.8.

4. The display apparatus according to claim 3 wherein a ratio of D2:D1 is between 2.4 and 2.8.

5. The display apparatus according to claim 4 wherein D3 is approximately equal to D1+D2.

6. The display apparatus according to claim 1 wherein the top and bottom edges of the poster board have a first length L1 and the first and second lateral edges of the poster board have a second length L2, the first length L1 being greater than the second length L2, and wherein the first and second strips of adhesive extend substantially parallel to the top and bottom edges of the poster board.

7. The display apparatus according to claim 1 further comprising a first release sheet coupled to and covering an entirety of the first strip of adhesive and a second release sheet coupled to and covering an entirety of the second strip of adhesive, the first and second release sheets being distinct and spaced apart from one another.

8. The display apparatus according to claim 7 wherein the front surface of the poster board comprises a first color, the rear surface of the poster board comprises a second color, and the first and second release sheets comprise a third color, each of the first, second, and third colors being different.

9. The display apparatus according to claim 1 wherein a ratio of (D3+D1):D2 is between 1.5 and 2.0.

10. The display apparatus according to claim 1 wherein the first and second strips of adhesive are formed from rubber cement.

11. A display apparatus comprising:
a poster board comprising a top edge, a bottom edge, a first lateral edge, a second lateral edge, a front surface, and a rear surface;
a first strip of adhesive positioned on the rear surface of the poster board and extending from the first lateral edge to the second lateral edge, the first strip of adhesive spaced a first distance D1 from the top edge of the poster board;
a second strip of adhesive positioned on the rear surface of the poster board and extending from the first lateral edge to the second lateral edge, the second strip of adhesive spaced a second distance D2 from the bottom edge of the poster board; and
wherein a ratio of D2:D1 is between 2.4 and 2.8.

12. The display apparatus according to claim 11 wherein the front surface of the poster board is free of any adhesive thereon.

13. The display apparatus according to claim 11 wherein the ratio of D2:D1 is between 2.5 and 2.7.

14. The display apparatus according to claim 11 wherein the first and second strips of adhesive have a width, measured in a direction parallel to the first and second lateral edges of the poster board, of between 1 mm and 5 mm.

15. The display apparatus according to claim 11 further comprising:
a first release sheet coupled to and covering an entirety of the first strip of adhesive and a second release sheet coupled to and covering an entirety of the second strip of adhesive, the first and second release sheets being distinct and spaced apart from one another; and
wherein the front surface of the poster board comprises a first color, the rear surface of the poster board comprises a second color, and the first and second release sheets comprise a third color, each of the first, second, and third colors being different.

16. The display apparatus according to claim 11 wherein the first and second strips of adhesive are formed from rubber cement.

17. A display apparatus comprising:
a poster board comprising a front surface and a rear surface opposite the front surface;
a first strip of adhesive and a second strip of adhesive positioned on the rear surface of the poster board;
a first release sheet coupled to and covering the first strip of adhesive and a second release sheet coupled to and covering the second strip of adhesive; and
wherein the first and second strips of adhesive are formed from rubber cement.

18. The display apparatus according to claim 17 further comprising:
the poster board comprising a top edge, a bottom edge, a first lateral edge, and a second lateral edge;
each of the first and second strips of adhesive extending from the first lateral edge to the second lateral edge so as to be parallel to the top and bottom edges, the first strip of adhesive spaced a first distance D1 from the top edge of the poster board and the second strip of adhesive spaced a second distance D2 from the bottom edge of the poster board, the second distance D2 being greater than the first distance D1.

19. The display apparatus according to claim 17 wherein the front surface of the poster board is free of any adhesive thereon and wherein a ratio of D2:D1 is between 2.5 and 2.7.

20. The display apparatus according to claim 17 wherein the first and second strips of adhesive have an adhesive strength such that the first and second strips of adhesive can be readily removed from the rear surface of the poster board under ambient conditions without damaging the poster board.
